(19) United States
(12) Patent Application Publication
(10) Pub. No.: US 2004/0047299 A1
(43) Pub. Date: Mar. 11, 2004

(54) Diskless operating system management

(76) Inventors: Alan D. Dorundo, Boca Raton, FL (US); Chester A. Heath, Boca Raton, FL (US); Kendall A. Honeycutt, Boca Raton, FL (US); Charles Douglas Haigh, Cary, NC (US); Carl Thomson, Delray Beach, FL (US)

Correspondence Address: KAPLAN & GILMAN , L.L.P., 900 ROUTE 9 NORTH, WOODBRIDGE, NJ, 07095, US

(21) Appl. No.: 10/445,457

(22) Filed: May 27, 2003

Related U.S. Application Data
(60) Provisional application No. 60/384,761, filed on May 31, 2002.

(51) Int. Cl. H04L 12/28

(52) U.S. Cl. 370/254

(57) ABSTRACT

A computer system includes one or more single board computers (“SBCs”), that are arranged connectively with a personal computer that acts as a host computer for the entire system. The host computer contains standard I/O and storage devices, including a hard disk drive, video monitor, mouse and keyboard. The SBCs do not contain such devices. Rather, the SBCs are managed using a single GUI utility generated by through the host computer; and the SBCs use one or more partitioned portions of the host computer's hard disk drive as storage. Images may be swapped on and off the SBCs rapidly to reconfigure their respective “personalities”.

### RELATED APPPLICATION

This application claims priority to U.S. Provisional Application No. 60/384,761, filed May 31, 2002.

### TECHNICAL FIELD

This invention relates to a networked computing system, and more particularly, a system wherein a host computer can manage a number of individual computers and the individual computers can interact with the host and can interchangeably run different operating systems and programs, and change between different ones of these on the fly.

### BACKGROUND OF THE INVENTION

Typical modern-day computer networks utilize a number of disparate hardware and software components to facilitate communication among the networked computers. Transmission control protocol/Internet protocol (“TCP/IP”) network communication standards are the most prolific today. They are the standards used on the Internet and in countless other home, office, local and wide area networks. To utilize these standards, computer networks require some or all of the following: network interface cards (“NICs”) for each computer, hubs, routers, switches, software drivers for all of these pieces of hardware, and various wires and cables to interconnect all of this hardware.

A typical four computer, small office network may be configured as follows:

1 host personal computer or server

3 satellite personal computers or nodes

4 network operating systems (one for each personal computer)

4 NICs (one for each personal computer)

4 NIC software drivers (one for each personal computer)

1 hub

1 hub software driver

Total=18 components, plus assorted wire and cable

Not only are there 18 components in this network, but also the three nodes are each fully outfitted personal computers, including disk drives, memory and CPUs comparable to the demands of the network. These nodes each take up all of the space, energy and expense that is associated with a personal computer. Also, the hub and the three nodes are separate from the host computer; each requires driver software and the three nodes each require independent network operating systems. The physical separation of the hardware slows down the speed of the network simply because the data has to travel physically farther than it would if the components were all onboard the host computer. The necessary overhead software slows down the speed of the network by adding functions to the system that must be processed by the various computers.

Also, the operating systems used by the various computers within a given network are generally wed to their particular systems. These operating systems are generally stored onboard each node in its hard drive. In a given network, should a node running a particular operating system crash due to some catastrophic failure, there is no easy was to swap the operating system out of the failed node and into another node which may be running some other operating system. Nor is there an easy way to swap an unblemished, golden master operating system if the operating system being used by a particular node becomes corrupted and renders the node unusable.

In the scenario wherein the node fails, a user or administrator would need to manually move the operating system and all associated applications software to a second node by either 1) physically removing the hard drive from the failed node and transferring it to the second node, or 2) ghosting the drive, copying the entire contents of the failed node's hard drive to the second node's hard drive, if possible. In the scenario where the operating system becomes corrupted, if the identical operating system has been saved on another computer, purely for backup purposes, or is available online from its developer, it can be ghosted onto the hard drive of corrupted node. If not, the entire operating system must be manually reloaded from CD-ROM or floppy disk, a time and labor intensive process. Disks, which have become virus-infected, are often removed, discarded and replaced with a fresh rebuild or duplicated copy. None of these actions can be done on-the-fly. Each requires the manual manipulation of hardware and/or software, and usually will require the shutdown and rebooting of the nodes involved.

In short, prior multinode computer systems typically consist of numerous relatively independent and noninterchangeable nodes, each of which is relatively fixed in functionality with respect to the remainder of the network nodes, and each of which is thus relatively inflexible.

### OBJECTS AND SUMMARY OF THE INVENTION

It is an object of this invention to provide a self-contained, high-speed networked computer system.

It is another object of this invention to provide a computer system wherein a number of individual computers are contained within and interact with a single host computer. Preferably, the individual computers are single board computers (SBCs).

It is still another object of this invention to provide a computer system wherein each individual computer is managed by a single host computer and can access one or a group of data storage devices via the host computer.

It is yet another object of this invention to provide a computer system wherein each individual computer may interchangeably operate a different operating system or application at any given time and may change operating systems or applications on the fly.

It is another further object of this invention to provide a computer system wherein each individual can typically be managed via a single utility to monitor and control the SBC and operating system/application environments. The utility is designed with a graphical user interface (“GUI”) for human interface or command structure when directed by automated equipment.

It is still a further object of the invention to provide a system of SBCs that can take on a variety of different personalities depending upon the image loaded onto the SBC to operate and configure it.

The computer system includes one or more SBCs, that are arranged in the slots of a PCI bus of a personal computer that may act as a host computer for the entire system. The host computer contains standard I/O and storage devices, including a hard disk drive, video monitor, mouse and keyboard. The SBCs need not contain such devices. Rather, the SBCs are managed using a single utility generated through the host computer; and the SBCs use one or more partitioned portions of the host computer's hard disk drive as storage.

Each SBC contains a module to interface with the PCI bus of the host computer. The module is comprised of an SBC-side network communication adapter, a host-side network communication adapter and a wide silicon media path between the two adapters. This module is direct and exclusive in its interface between the specific SBC and the host computer. No wires, hubs, routers or extraneous network cards need be interposed between the host and the SBC. This facilitates remarkable data transfer speeds that are not limited by distance or network capacity, only by the speed of the PCI bus, the CPUs of the host computer and SBC and the software they are each running. The communications software for the host and the SBC with which it communicates are normally stored together, to ensure that the same version of software is utilized on both sides of the communications link, and that the host and SBC software is loaded together.

The module operates generally using well-known TCP/IP network communication standards and thus is compatible with most hardware, software and network applications. However, it differs from typical uses of TCP/IP in that the adapters for both ends of the peer network are 1) resident on the SBC module, and 2) the drivers for these adapters are always loaded onto both the SBC and the host computer together, ensuring compatibility. Further, data transfers from the module can be tagged as file operations, not including boot or startup functions. File operations do not require the processor and memory capacity necessary to perform network functions. This again facilitates much greater speed than is available via a typical client/server network configuration using mapped files in TCP/IP standards. The module can also operate using network protocols other than TCP/IP to similar effect.

In this computer system, while the host and the SBC generally interact as a TCP/IP network, file operations interface at the module, along a physical layer, without the processor and memory overhead that is typical of TCP/IP networks. The SBC basic input/output system (“BIOS”) redirects file operations from its onboard disk adapter, directs them to the SBC drive and tags such operations as “special file operations.” The host driver interprets this tag as a file operation. The data is then either written to or read from a “virtual file partition” on the hard drive that is organized by track and sector, just as a physical file is. The hard drive in its entirety is embedded in one large virtual file partition, which appears to the host operating system as a single large file. The virtual file partition works with all variety of files, including data files, application files and the boot record, such that the virtual partition is a complete substitute for an actual, physical file storage device.

The virtual partitioned files usually appear as large, but otherwise ordinary data files to the host computer into the hard drive of which they are installed. For disk creation and file maintenance, these files can also be mounted as files to the host system. The SBC and the host computer can maintain an exact association between each SBC and its appropriate virtual partition file due to private and dedicated modular path between each SBC and the host. Multiple virtual partitioned files may be stored on the host computer's hard drive or disk subsystem.

The reduction of these components saves space and increases network speed by cutting down the number of software processes and eliminating hub processes. Plus, because the nodes' processing power is centrally located in the SBC, the actual nodes themselves may be inexpensive “dumb” terminals, essentially monitors, keyboards and de minimus CPUs. The high network speed enables high bandwidth operations, such as motion video, high resolution graphics, animation and time dependent responsiveness common in games between the “thin client” SBC cards and the host, operating as an application processor. The result is a thin client that can more closely emulate a PC when operating software applications that define these operations.

Each SBC in the computer system is capable of swapping operating systems with another SBC substantially instantly when followed by a reset, restart or shutdown simply by changing the pointers in the management utility that defines the association between virtual disk image and a given SBC. For example, should one SBC fail, a second SBC can be directed, either manually or automatically, to access the “image” of the operating system and/or applications that was being used by the first SBC. This image is stored in the virtual partition file that was associated with the first SBC. The second SBC is reassociated from its virtual partition file to that of the first SBC. The second SBC then functions as the first SBC. This process can be repeated as necessary, whether associating a “spare” SBC or virtual disk image that was previously not in use or reassociating another SBC that was in use for a lower priority function.

Virtual Disk Management

A further function of this computer system is virtual disk management. All of the virtual files in use by the host computer and the individual SBCs are on the host's disk system and are under the direct control of the host's processor. Virtual disk management is a utility that allows a user to control the creation, replication, assignment, destruction and other management of the virtual partition files. The utility allows an entire operating system, including Windows, Linux and Unix systems, to be installed into a virtual partition file. The utility allows SBCs only to access these operating systems. Further, the utility allows only an SBC to access an operating system, as contained within a virtual partitioned file, with which it has been specifically associated. This provides a user or network administrator control over the use of licensed software and helps prevent unauthorized use of such software.

The virtual disk management utility typically employs a graphical user interface (“GUI”) for user input/output. The GUI is comprised of enumerators with pull down menu windows to facilitate user control of the computer system. Each SBC in the computer system is depicted as an icon and is listed either by its MAC address or by any other convenient identifier that the user may designate. The virtual partition file images that are in the computer system are also depicted as icons. Alternatively, the utility can respond to command strings through a text oriented command port or a web based interface.

The menus control the actions of the SBCs and the host computer-based file storage devices, such as the hard drive. In regard to the SBC, the menus allow the user to control the virtual partition file image available to a specific SBC from the host drive and allow the user to reset, reboot or shutdown each SBC, individually or as a group. In regard to the host computer, the menus allow the user to copy an image or create one from an existing image imported to the system from an external source. This feature allows one image to be the seed for many images (operating systems/applications/program groupings) thereby radically reducing the deployment time in large configurations. The menus also allow for the deployment of a new configuration entirely within the computer system, without the need for removal and ghosting of actual drives. Such a utility would typically communicate to the host operating system via an Application Programming Interface (API).

The virtual disk management utility also permits the deletion of a virtual partition icon or the assignment of one or more virtual partition icons to a selected SBC, as a more typical C: drive or D: drive, etc. identifier. The utility also permits the same file or image to be assigned to multiple SBC, so long as it is labeled read-only and thereby not alterable by the variety of SBC users.

It is possible to have more virtual partition file images created than SBCs in a given computer system of the present invention. Extra images may be pre-configured operating system environments with defined application configurations, which may be alternately loaded into the SBCs. Extra images may also be hot-standby replacements for software environments that become corrupted. Or extra images may be “golden” images from which new standby and active image are created. The ability to pre-configure complex operating system and application scenarios reduces both the setup time and the user requirement for in-depth knowledge of the desired application. The virtual disk management utility can also respond to scripts through the command port that permit macro functions for automatic swap-on-the-fly of images, such as “discard and replace image with backup image and create backup image from golden master image.” Any one or more of the SBCs or host may serve to distribute the images at various points in operation of the system to other SBCs.

### BREIF DESCRIPTION OF THE DRAWINGS

FIG. 1 is an overview diagram showing the computer system of the present invention.

FIG. 2 is a schematic diagram showing the interface between the host computer and the individual computers of the present invention;

FIG. 3 is a schematic diagram showing the communication module and PCI bus of the present invention;

FIG. 4 is a diagram of the graphical user interface of the virtual disk management utility of the present invention;

FIG. 5 is a schematic flowchart showing a method using the virtual disk management utility of the present invention;

FIG. 6 is a schematic flowchart showing an alternate method of using the virtual disk management utility of the present invention.

### DETAILED DESCRIPTION OF THE PREFERRED EMBODIMENT

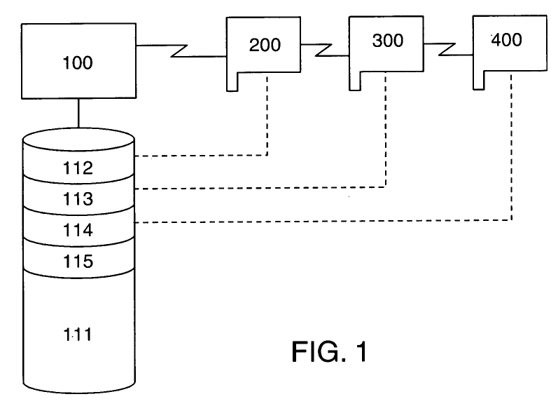

In the exemplary embodiment of the present invention shown in FIG. 1, the host computer 100 is a typical personal computer, having a hard disk drive 110 and a PCI bus 120. Single board computers (“SBCs”) 200, 300, 400 are identical in physical dimension and resemble typical PCI bus-compatible computer peripherals, such as network interface cards, internal modems, sound cards and video cards. The resemblance is such that SBCs 200, 300, 400 are physically and communicatively PCI bus-compatible.

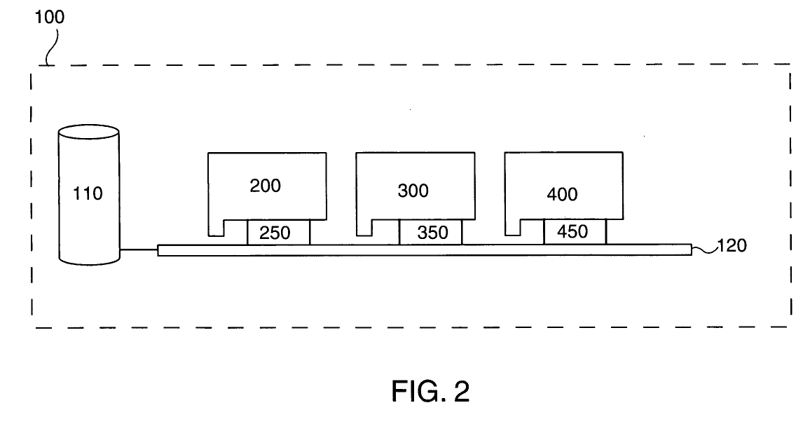

As shown in FIG. 2, SBC 200 physically and communicatively connects with host computer 100 via a communication module 250 on SBC 200 and PCI bus 120 on host computer 100. PCI bus 120 is communicatively connected to the other components of host computer 100. SBCs 300 and 400 plug into further open slots along PCI bus 120, in a manner identical to that of SBC 200. SBC 300 connects with PCI bus 120 via module 350. SBC 400 connects with PCI bus 120 via module 450.

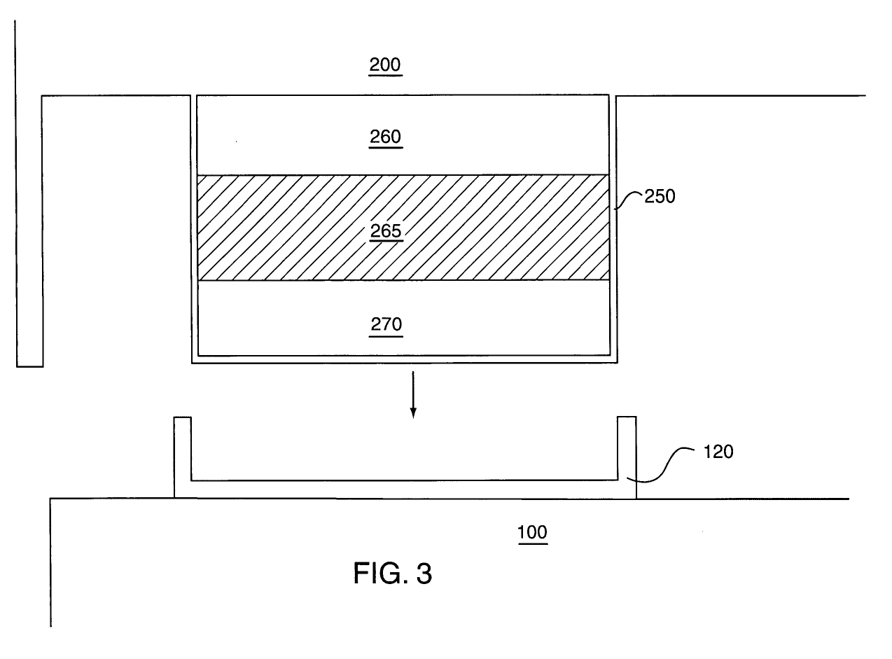

As shown in FIG. 3, module 250 of SBC 200 is comprised of two Gigabit Ethernet adapters, 260 and 270, and a wide silicon media 265, together in an IC chip configuration. Adapter 260 is an SBC-side adapter and facilitates SBC 200 communication with host computer 100. Adapter 270 is a host-side adapter and facilitates host computer 100 communication with SBC 200. Silicon media 265 provides a physical connection between adapters 260 and 270, which is the path followed by the communication between the two adapters. When SBC 200 is plugged into PCI bus 120, adapter 270 is the portion of it that is in physical and communicative contact with PCI bus 120. Thus, unlike in a typical network configuration, host computer 100 does not require its own onboard network adapter to facilitate communication with other computers on the network. SBCs 300 and 400 are similarly configured to communicate with host computer 100 in the same manner as SBC 200 does. Modules 350 and 450 are identical to module 250.

Hard drive 110 may be a typical personal computer storage device or other storage media, such as a Storage Area Network. Its storage space is virtually partitioned, that is there are no physical partitions, into five portions, 111, 112, 113, 114 and 115 as shown in FIG. 1. Portion 112 is assigned to SBC 200, portion 113 is assigned to SBC 300 and portion 114 is assigned to SBC 400. The remainder of the storage space on hard drive 110 is not assigned to any of the SBCs and can be made available to the host system. Each SBC may only access that portion which is assigned to it. Each portion may contain all variety of files, including data files, application files and boot record. The host computer may view the entire contents hard drive 110. Typically, it can only view the contents of each portion assigned to an SBC as a single, virtual partitioned file, not as the collection of individual files available to the SBC to which the portion is assigned. An exception to this usual mode of operation is when an authorized administrator can mount the file to the host system for initial creation and maintenance of virtual disk images. Host computer 100 can freely access unassigned portion 111 of the storage space, for all computing purposes. Other portions of hard drive 110 may be partitioned and filled with files, such as secondary operating systems or applications. An example of this is partitioned portion 115. It is initially not assigned to any SBC but may be assigned either manually by a user or automatically as a contingency upon the realization of some action. This function is discussed further, infra.

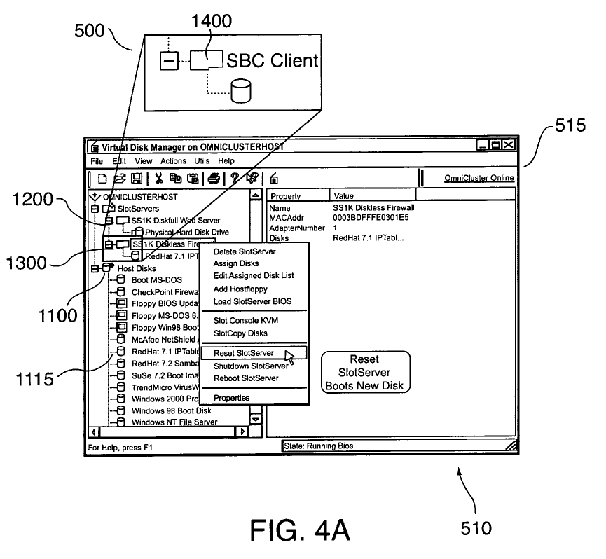

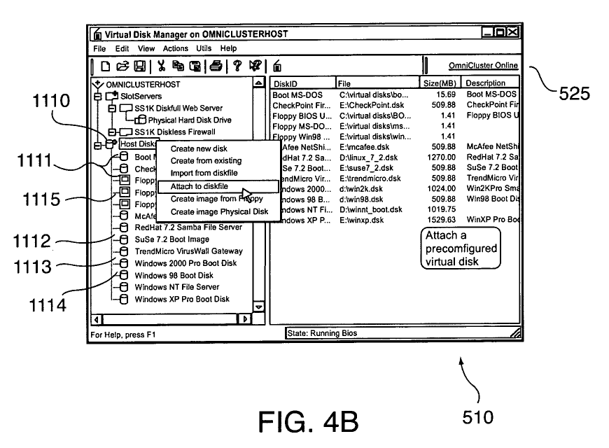

As shown in FIGS. 4a and 4b, the computer system is controlled by a virtual disk management software utility, VDM utility 500. VDM utility 500 contains an Application Programming Interface to the operating system, a GUI user interface, a command line interface for responding to command scripts and a monitoring service to detect the status and state of the SBC(s). VDM typically employs a GUI 510 for user input/output. GUI 510 is comprised of two pull-down window enumerators 515 and 525. Each SBC in the computer system is depicted as an icon. Referring to FIGS. 1, 4a and 4b, SBC 200 is depicted by icon 1200, SBC 300 is depicted by icon 1300, and SBC 400 is depicted by icon 1400. Each icon is listed either by the MAC address of its associated SBC, or by any other convenient identifier that the user may designate. The virtual partition file images that are in the computer system are also depicted as icons. Each image may be the entire contents of a virtual disk, including the operating system and applications software, as well as any other data.

Portion 111 is depicted as icon 1111, portion 112 is depicted by icon 1112, portion 113 is depicted by icon 1113, and portion 114 is depicted as icon 1114. The entire hard drive 110 is depicted by icon 1110. Each of these portions operates as its own virtual disk with its own image, and, as explained herein, can be hot swapped onto other SBCs when needed. Alternatively, these virtual disk devices could be created by VDM as virtual floppy drives, virtual CD-ROM devices and so on (e.g., floppy icon 1115). A virtual floppy disk may be implemented to emulate a removable disk device for the installation process when creating virtual disk images from standard software installation processes. The virtual disk devices can be mounted to the host system for initial creation and maintenance of virtual disk images, but the virtual disk devices are typically assigned to the SBC's as file resources. For system security, only an authorized system administrator typically invokes this function.

Pull down menu 515 controls the actions of SBC 200, 300 and 400. By clicking on the representative icons in menu 515, the user can control the assignment of virtual partition file images available to each SBC 200, 300 and 400 from hard drive 110. Menu 515 also allows the user to reset, reboot or shutdown each SBC 200, 300 and 400, individually, selected SBCs, or as a group. Pull down menu 525 controls the actions of hard drive 110. Menu 525 allows the user to copy an image or create one from an existing image imported to the computer system from an external source. Menus 515 and 525 also allow the user to program VDM utility 500 to perform reassignment of images via a scripted macro function. The Command Line interface permits this to be automated subordinate to a higher-level system control utility. The scripts may act as a function of time, upon the completion of an activity by the system, started as a result of the VDM monitoring service, or as a contingency for a catastrophic failure within the computer system.

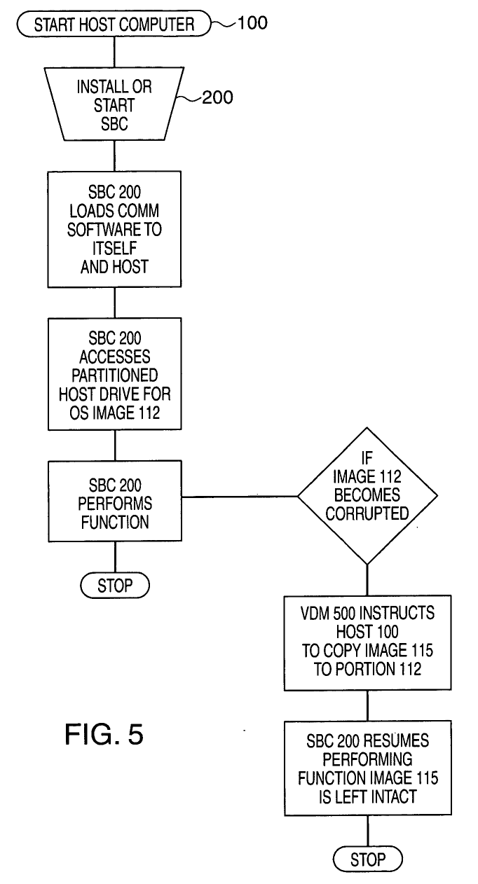

One contingency for which a script can be implemented is the corruption of a software environment being run by an SBC. A script may be implemented VDM utility 500 wherein a golden image of a corrupted environment's operating system and programs replace the corrupted image. This is illustrated in the flowchart of FIG. 5. Host computer 100 is booted up. SBC 200 is either booted up simultaneously with host computer 100 or alternatively installed into host computer 100, via PCI bus 120, as shown in FIG. 3. As SBC 200 is booted/installed, it loads driver software into itself and host computer 100 loads its driver software effectively at the same time, to facilitate network communication with host computer 100. Hard drive 110 is virtually partitioned into portions 111, 112 and 115. Portion 112 is assigned to SBC 200 and contains an image comprised of a specific operating system, set of programs and data files. The image of portion 112 is altered over time as it is accessed and used by SBC 200. Portion 115 contains the same image that portion 112 initially contains. However, portion 115 is not assigned to any SBC nor is it available to host computer 100. This image, which remains unaltered in portion 115, is the golden master image. Portion 111 is not assigned to any SBC but is available to host computer 100 for general functions. It should be noted that this feature to have both adapters in the same chip, which when made to respond to an automated installation process yields matched pairs of drivers that know how to intepret specialized protocols, can also be used to eliminate much of the protocol stack executed by software in both host and card, yielding a dramatic reduction in software latency and improvement in performance. Similar results can be achieved by locating the adapters on multiple chips on the same board.

Over time, the image of portion 112 may become corrupted due to a variety of circumstances, including a read/write error on the portion of hard drive 110 that carries portion 112, a computational/processing error or a virus. If the corruption is severe enough, SBC 200 can no longer perform its assigned function. Should SBC 200 fail due to a severe level of corruption of the image portion 112, VDM utility 500 will automatically perform a swap-on-the-fly of the images of portion 112 and 115. The image of portion 115 is an uncorrupted golden image of portion 112. VDM utility 500 will discard the corrupted image of portion 112 and create a new golden image in portion 112 by copying the image of portion 115. SBC 200 will then continue operation using the new golden image of portion 112 and the golden master image of portion 115 will remain available in its unaltered state for future corrective use. VDM utility 500 can also be manually instructed to make such a replacement if the user desires to return the initial, unaltered parameters of the image with which he/she was operating SBC 200, regardless of whether the image of portion 112 has become corrupted.

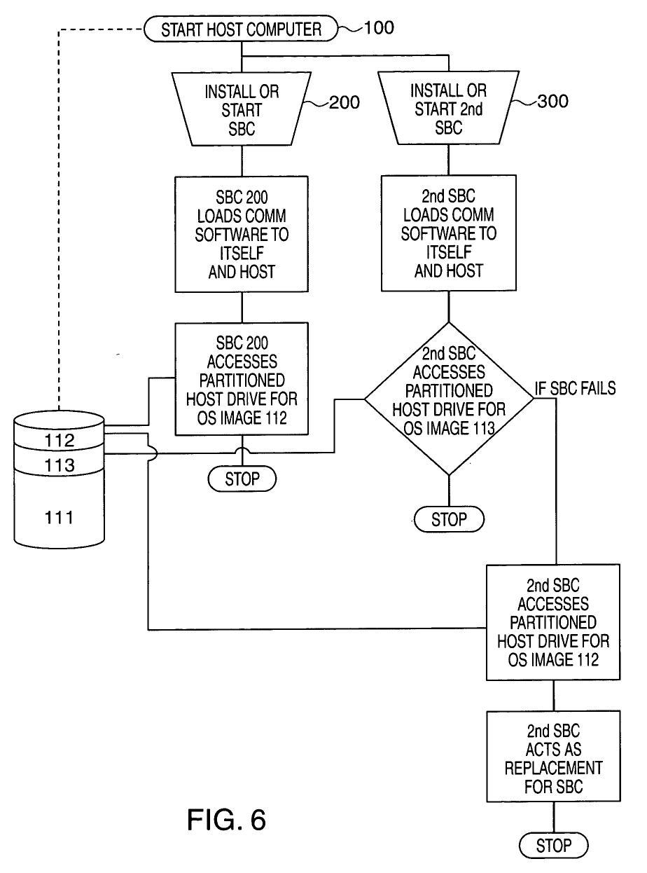

Another contingency for which a script can be implemented is the failure of an SBC performing a high priority function. A script may be implemented in VDM utility 500 wherein the operating system and programs of a failed higher priority function are swapped on-the-fly onto an SBC performing a lower priority function. This is illustrated in the flowchart of FIG. 6. Host computer 100 is booted up. SBCs 200 and 300 are either booted up simultaneously with host computer 100 or alternatively installed into host computer 100, via PCI bus 120, as shown in FIG. 3. As SBCs 200 and 300 are booted/installed, each one loads driver software into itself and host computer 100, to facilitate network communication with host computer 100. Hard drive 110 is virtually partitioned into portions 111, 112 and 113. Portion 112 is assigned to SBC 200. SBC 200 accesses portion 112, via network communication with host computer 100, and loads the operating system and other programs contained in the virtual program file in portion 112.

For purposes of this embodiment of the invention, this virtual program file is designated as the highest priority in this computer system. Portion 113 is assigned to SBC 300. Portion 111 is not assigned to any SBC but is available to host computer 100 for general functions. SBC 300 accesses portion 113, also via network communication with host computer 100, and loads the operating system and other programs contained the virtual file program in portion 113. Both SBC 200 and 300 then run their respective operating systems and programs. Should SBC 200 fail for some reason, VDM utility 500 (not illustrated in FIG. 6) will automatically reassign the higher priority virtual file in portion 112 to SBC 300. SBC 300 will then swap from its current operating system and programs in the virtual file of portion 113 to the operating system and programs in the virtual file of portion 112. SBC 300 will then run this higher priority operating system and programs until such time as it is reassigned to perform another task, thus insuring that higher priority tasks are executed even though the SBC assigned to those tasks has failed.

Because all of the images that might be needed for all of the SBCs are stored within the same system, and all can be communicated and rapidly loaded via the local computer bus, each SBC is flexible and may take on a personality that is configurable, depending upon which of plural images are loaded into it. The images may be distributed to the SBCs by one predetermined SBC, by the host, in accordance with macros or GUI interfaces, or based upon any other desired and/or programmable criteria. The image may cause the SBC to operate as a client, a server, a data server, a webserver, load balancer, firewall, or any other type of device. Additionally, by restricting the particular images that may be loaded onto particular SBCs, licensing policies may be enforced or implemented. The physical media that stores the plural virtual drives may be any storage media or combination thereof, rather than simply a fixed drive.

I claim:

1. A computer system comprising at least one single board computer and a host with which said single board computer communicates over a local area network, the single board computer being configured to load communications software for facilitating communications between the single board computer and the host over a network, the host being configured to communicate using communications software, the communications software for the host and the communications software for the single board computer being loaded substantially simultaneously by the computer system.

2. The computer system of claim 1 wherein the communications software adapter for the single board computer and the communications adapter for the host computer are implemented on a single chip, or multiple chips on the same board.

3. The computer system of claim 2 wherein the single chip is resident on the host computer.

4. The computer system of claim 1 wherein said host and said plurality of single board computers communicate with said host and each other using a standardized network protocol.

5. The computer system of claim 1 wherein said standardized network protocol does not require any extraneous software to facilitate said communication.

6. A computer system having a host and a plurality of single board computers that communicate with said host and each other over a bus, the host including software to instruct the single board computers to operate as a specified type of computer by causing an image to load into said single board computer from disk shared among the host and single board computer, thereby causing the single board computer to be configured to act as a type of computer corresponding to the image loaded.

7. The computer system of claim 6 wherein the single board computer contains a communication module, comprising two network adapters connected by a communicative media, wherein one adapter facilitates communication by the single board computer and said other adapter facilitates communication by the host computer.

8. The computer system of claim 6 wherein said disk is partitioned such that each single board computer can access a partitioned portion of the disk as if it were a physical I/O device.

9. The computer system of claim 8 wherein said partitioned portion of the disk is available only to a designated associated single board computer.

10. The computer system of claim 6 wherein the single board computer being configured to load communications software for facilitating communications between the single board computer and the host over a network, the host being configured to communicate using communications software, the communications software for the host and the communications software for the single board computer being loaded substantially simultaneously by all SBCs and Hosts in the computer system.

11. The computer system of claim 10 wherein data transfers between said host computer and said single board computer are tagged as file or other specified non-network operations.

12. The computer system of claim 6 wherein each of said single board computers and said host runs an operating system.

13. The computer system of claim 6 wherein said operating systems are the same as each other.

14. The computer system of claim 6 wherein said operating systems are different from each other.

15. The computer system of claim 6 wherein said single board computers operates as a firewall.

16. The computer system of claim 6 wherein said single board computers operates as a load balancer.

17. The computer system of claim 6 wherein said single board computers operates as a dispatcher.

18. The computer system of claim 6 wherein said single board computers operates as a web server.

19. The computer system of claim 6 wherein said single board computers operates as a proxy server.

20. The computer system of claim 6 wherein said single board computers operates as a server monitor.

21. The computer system of claim 6 wherein said single board computers operates as a client.

22. The computer system of claim 6 wherein said single board computers operates as a database server.

23. The computer system of claim 6 wherein said single board computers operates as a network appliance platform.

24. The computer system of claim 6 wherein said single board computers operates as an application server.

25. The computer system of claim 6 further comprising a command line or Graphical User Interface (GUI) for allowing a user to input commands regarding the configuration of one or more of said single board computers.

26. The computer system of claim 6 wherein a first single board computer is configured to emulate a second single board computer upon the failure of said second single board computer.

27. The computer system of claim 6 wherein at least one of said single board computers is configured to distribute images to configure other ones of said single board computers to act as a specified type of computer.

28. The computer system of claim 6 wherein a user inputs an identification and said identification is associated with a set of one or more images being loaded into one or more single board computers, and wherein the input of said identification causes the loading of said associated set of one or more images to configure the single board computers in the computer system.

29. A method of configuring plural single board computers in a computer system to each operate as an independent computer, the method comprising distributing images to plural single board computers, each image including at least an operating system, the single board computers sharing nonvolatile storage, the image including one or more applications and security information, the security information authorizing the applications to execute only on specified ones of the single board computers but not on other ones of the single board computers.

30. The method of claim 29 wherein the security information is an authentication code.

31. The method of claim 30 wherein a host computer, with which all of said single board computers communicate, distributes the images.

32. The method of claim 31 wherein one of said single board computers distributes the images to other ones of said single board computers.

33. The method of claim 29 further comprising storing plural images on a nonvolatile storage device, and distributing a copy of one or more of said images to one or more of said single board computers.

34. The system of claim 6 wherein one of said SBCs or said host acts as a disk manager and is configured to monitor a state and status of other SBCs in said system.

35. The system of claim 34 wherein upon detection of a particular status, a command string is issued from said disk manager to one or more SBCs.

36. The system of claim 6 configured to operate as a filtering and security computer system.

37. The system of claim 28 wherein predetermined images and SBCs are restricted so that only a subset of images is operable on a subset of SBCs.
